(19) United States
(12) Patent Application Publication
(10) Pub. No.: US 2016/0069480 A1
(43) Pub. Date: Mar. 10, 2016

(54) CORD SUPPORT BRACKET

(71) Applicant: Lawrence Rego, Waxhaw, NC (US)

(72) Inventor: Lawrence Rego, Waxhaw, NC (US)

(21) Appl. No.: 14/945,672

(22) Filed: Nov. 19, 2015

Related U.S. Application Data
(63) Continuation-in-part of application No. 14/169,779, filed on Jan. 31, 2014, now Pat. No. 9,222,603.
Application No. 14/169,779 is a continuation-in-part of application No. 13/851,887, filed on Mar. 27, 2013, now abandoned.

(51) Int. Cl. F16L 3/00; F16M 13/02

(52) U.S. Cl. CPC F16L 3/00; F16M 13/027

(57) ABSTRACT

A cord support assembly includes: a threaded rod; a pipe fitting over the threaded rod; an upper flange nut with a shank and a flange, the upper flange nut fits on the threaded rod, and the shank fits into the pipe and the flange rest on the pipe; a lower flange nut with a shank and a flange, the lower flange nut threads on the threaded rod, the shank fits into the pipe and the flange rests on the pipe; a support bar engages the threaded rod; and a nut, the support bar engages the threaded rod between the lower flange nut and the nut. The threaded rod, pipe, upper and lower flange nuts, when assembled, reducing any sway of the support bar.

### RELATED APPLICATIONS

This application is a continuation-in-part of application Ser. No. 13/851,887, filed Mar. 27, 2013, now abandoned, and a continuation-in-part of co-pending application Ser. No. 14/169,779 filed Jan. 31, 2014, now U.S. Pat. No. ______. Each is incorporated herein by reference.

### FIELD OF THE INVENTION

This invention is directed to support brackets used to suspend cords from a structure (e.g., a ceiling).

### BACKGROUND OF THE INVENTION

Conventional methods for installing all types of cords, such as cables and conduits, require individual supports for the cords using straps or hangers. When multiple conduits are installed, the installer regularly builds custom racks using perforated channels, which involves using threaded rods, anchor nuts, washers and specialty clamps and fittings, which may be time consuming and expensive to build. When installing multiple types of cables, often the installer must purchase and install cable trays which may be time consuming to install and expensive.

The foregoing supports may, in some situations, sway (see FIG. 1, arrow A), for example as a result of seismic events. Such supports in areas subject to seismic events may require additional bracing to reduce or eliminate the sway.

There is a need for a single device that supports and organizes different types of cords and/or may have reduced chance of swaying.

### SUMMARY OF THE INVENTION

A cord support assembly includes: a threaded rod; a pipe fitting over the threaded rod; an upper flange nut with a shank and a flange, the upper flange nut fits on the threaded rod, and the shank fits into the pipe and the flange rest on the pipe; a lower flange nut with a shank and a flange, the lower flange nut threads on the threaded rod, the shank fits into the pipe and the flange rests on the pipe; a support bar engages the threaded rod; and a nut, the support bar engages the threaded rod between the lower flange nut and the nut. The threaded rod, pipe, upper and lower flange nuts, when assembled, reducing any sway of the support bar.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a perspective view of an embodiment of the invention.

FIG. 2 is an exploded view of the embodiment of FIG. 1.

FIG. 3 is a sectional view of an embodiment of the invention.

FIG. 3A is an embodiment of the upper flange nut.

FIG. 3B is an embodiment of the lower flange nut.

FIG. 4 is a sectional view of another embodiment of the invention.

FIG. 4A is an embodiment of the upper flange nut.

FIG. 4B is an embodiment of the lower flange nut.

### DESCRIPTION OF THE INVENTION

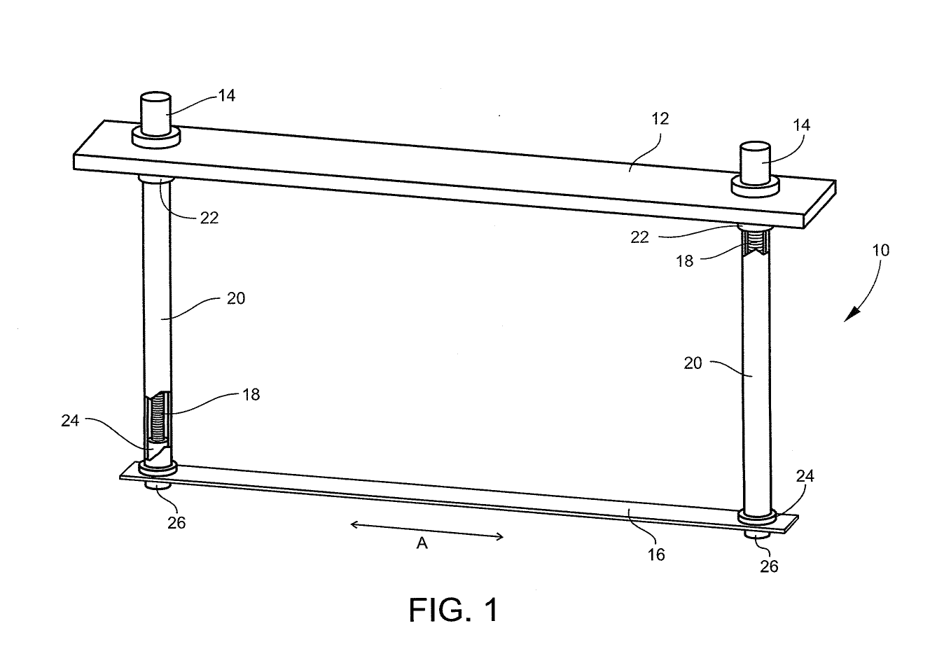

Referring to the drawings wherein like elements have like numerals, there is shown in FIG. 1 an embodiment of the instant invention, the cord support bracket 10. The support bracket 10 may support and neatly arrange multiple various types of cords. The support bracket 10 may be made from any kind of materials. For example, the bracket may be made of steel, aluminum, stainless steel, bronze, brass, copper, as well as, plastics.

The cord, as used herein, may include, but is not limited to, a cable, a wire, a conduit, a hose, a pipe and the like.

The bracket 10 may be anchored (or mounted or attached) to a structure 12. Structure 12 includes, for example, buildings, bridges, tunnels, and the like, and more specifically a part of the structure, such as a ceiling or wall.

Anchors 14 may be any conventional anchor used to attached a rod (or screw or bolt) into a solid surface. Such an anchor may be an internally threaded expansion anchor or an internally threaded double expansion anchor, or equal. Such an anchor may be lead, wood, or plastic anchor, or molly or polly bolt, or toggle bolt, or the like.

Support bracket 10 is shown in FIGS. 1 (assembled) and 2 (exploded). Bracket 10 generally includes: a threaded rod 18; a pipe 20; an upper flange nut 22; a lower flange nut 24; a support bar 16; and a nut 26.

Threaded rod 18 may be fully threaded (i.e., threaded along the rod's entire length, or partially threaded (i.e., threaded at the end of the rod), or any rod that the securely hold the hardware mentioned below.

Pipe 20 may be any type of tubular member with any cross-sectional (round, square, triangular, rectangular, oval, U of the like).

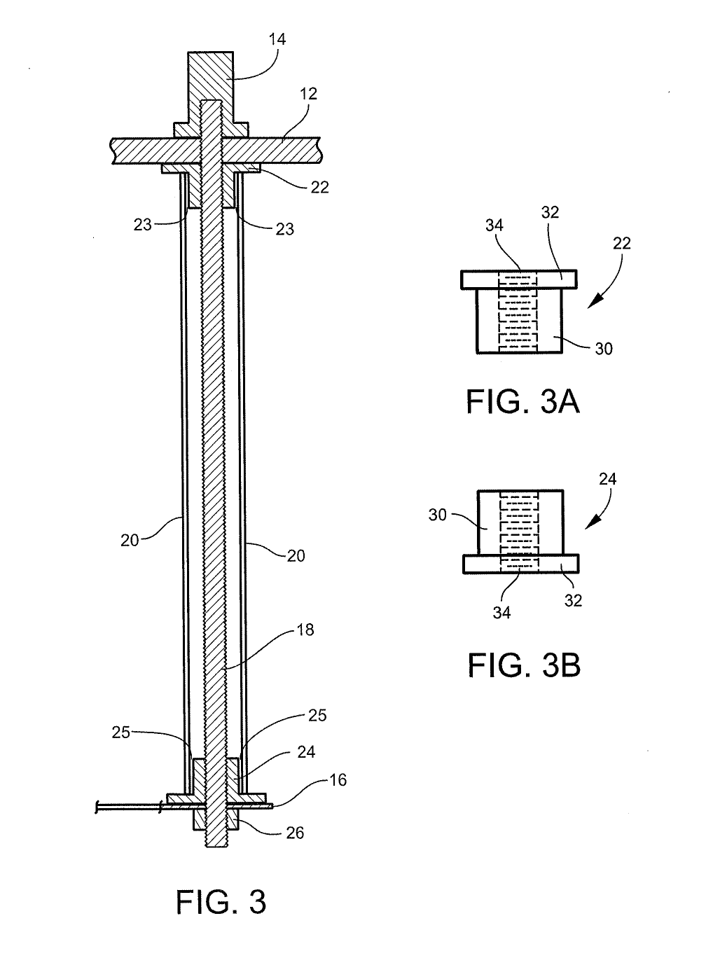

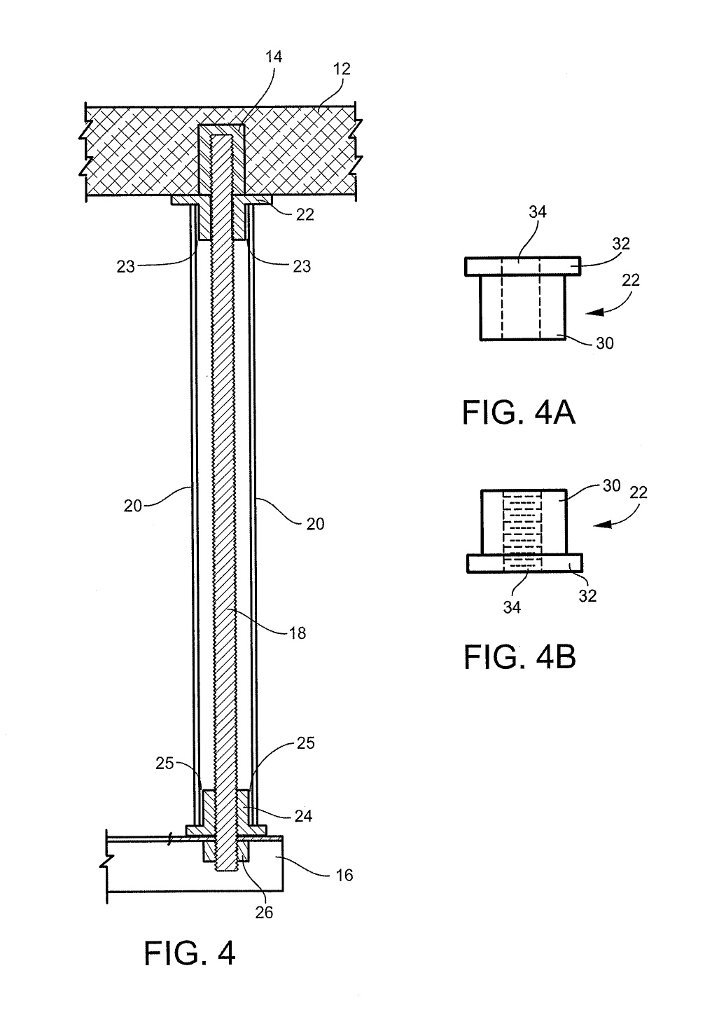

Flange nuts 22 and 24 generally include: a shank 30, a flange 32, and an axial hole 34 therethrough. The diameter of the flange 22 may be equal to or greater than the outside diameter of the pipe 20. The flange diameter may be 50% or more greater than the pipe diameter. The flange diameter may be 50-150% greater than the pipe diameter. Axial hole 34 of upper flange nut 22 may be threaded (FIG. 3A) or non-threaded (FIG. 4B). Axial hole 34 of lower flange nut 24 may be threaded (FIGS. 3B and 4B).

Support bar 16 may be a flat plate (FIG. 1), a tape, an angle iron (FIG. 4), a pipe or conduit, a channel, a beam (e.g., box or I), or the like.

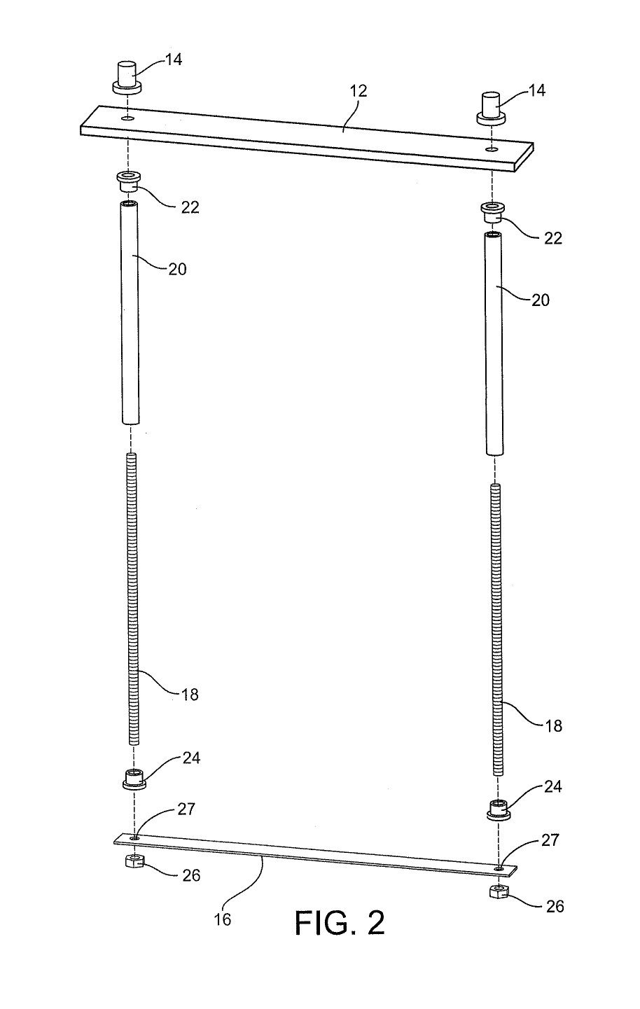

Bracket 10, in one embodiment (e.g. see FIGS. 1 and 2), includes a pair of threaded rods 18, pipes 20, upper flange nuts 22, lower flange nuts 24, and nuts 26, and a single bar 16 joining the threaded rods. Multiple brackets 10 may be used to form a system to support cords.

Referring to FIGS. 3 and 4, threaded rod 18 is anchored to structure 12 via anchors 14. Rods 18 may hang vertically from a ceiling. The upper flange nut 22 fits up against the structure 12. The pipe 20 fits over the threaded rod 18, abuts the flange 32 of the upper flange nut 22, and fits over (nests in)the shank 30 of the upper flange nut 22. There may be a gap 23 between the shank 30 and the pipe 20. The gap 23 is minimized (typically less than 1/16″). The lower flange nut 24 is threaded onto threaded rod 18. The shank 30 of the lower flange nut fits into (nests in) the pipe 20 and the flange 32 of the lower flange nut 24 rests on the pipe 20. There may be a gap 25 between the shank 30 and the pipe 20. The gap 25 is minimized (typically less than 1/16″). The bar 16, via hole 25, engages the threaded rod 18 and is fixed to the threaded rod 18 by nut 26.

When assembled (FIG. 1), sway A (e.g., caused by seismic activity) of the cords (supported on bar(s) 16) is minimized or eliminated. Thus, the instant invention has greater rigidity.

The present invention may be embodied in other forms without departing from the spirit and the essential attributes thereof, and, accordingly, reference should be made to the appended claims, rather than to the foregoing specification, as indicating the scope of the invention.

I claim:

1. A cord support assembly comprises:
a threaded rod;
a pipe fitting over the threaded rod;
an upper flange nut with a shank and a flange, the upper flange nut fits on the threaded rod, and the shank fits into the pipe and the flange rest on the pipe;
a lower flange nut with a shank and a flange, the lower flange nut threads on the threaded rod, the shank fits into the pipe and the flange rests on the pipe;
a nut; and
a support bar engages the threaded rod; the support bar engages the threaded rod between the lower flange nut and the nut;
the threaded rod, pipe, upper and lower flange nuts, when assembled, reducing any sway of the support bar.

2. The assembly of claim 1 wherein a diameter of the flange of the upper flange nut is greater than an outer diameter of the pipe.

3. The assembly of claim 2 wherein the flange diameter is at least 50% greater than the outer diameter of the pipe.

4. The assembly of claim 1 wherein a diameter of the flange of the lower flange nut is greater than an outer diameter of the pipe.

5. The assembly of claim 4 wherein the flange diameter is at least 50% greater than the outer diameter of the pipe.

6. The assembly of claim 1 wherein a gap is located between the shank of the upper flange nut and the pipe.

7. The assembly of claim 1 wherein a gap is located between the shank of the lower flange nut and the pipe.

8. The assembly of claim 1 wherein the assembly has a pair of threaded rods, pipes, upper flange nuts, lower flange nuts, and nuts, and one support bar.

9. A cord support assembly comprises:
a threaded rod;
a pipe fitting over the threaded rod;
an upper flange nut with a shank and a flange, the upper flange nut threads on the threaded rod, and the shank fits into the pipe and the flange rest on the pipe;
a lower flange nut with a shank and a flange, the lower flange nut threads on the threaded rod, the shank fits into the pipe and the flange rests on the pipe;
a nut; and
a support bar engages the threaded rod, the support bar engages the threaded rod between the lower flange nut and the nut;
the threaded rod, pipe, upper and lower flange nuts, when assembled, reducing any sway of the support bar.

10. The assembly of claim 9 wherein a diameter of the flange of the upper flange nut is greater than an outer diameter of the pipe.

11. The assembly of claim 10 wherein the flange diameter is at least 50% greater than the outer diameter of the pipe.

12. The assembly of claim 9 wherein a diameter of the flange of the lower flange nut is greater than an outer diameter of the pipe.

13. The assembly of claim 12 wherein the flange diameter is at least 50% greater than the outer diameter of the pipe.

14. The assembly of claim 9 wherein a gap is located between the shank of the upper flange nut and the pipe.

15. The assembly of claim 9 wherein a gap is located between the shank of the lower flange nut and the pipe.

16. The assembly of claim 9 wherein the assembly has a pair of threaded rods, pipes, upper flange nuts, lower flange nuts, and nuts, and one support bar.
